(19) United States
(12) Patent Application Publication
(10) Pub. No.: US 2004/0056433 A1
(43) Pub. Date: Mar. 25, 2004

(54) Sealing, trimming and finishing strips

(76) Inventors: Ewald Strehl, Monchengladbach (DE); Norbert Heller, Viersen (DE); Klaus Krawczyk, Monchengladbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/451,718

(22) PCT Filed: Nov. 19, 2001
(86) PCT No.: PCT/IB01/02176

(30) Foreign Application Priority Data
Dec. 21, 2000 (GB) 0031356.9

(51) Int. Cl. F16J 15/02

(52) U.S. Cl. 277/628

(57) ABSTRACT

A sealing, trimming or finishing strip has a gripping part (2) made of extruded elastomeric material and advantageously incorporating an embedded reinforcement or carrier (10). In use, the gripping part (2) embraces a flange (22) such as framing a closable opening in a motor vehicle body, to support a soft sealing part (4) which is compressed by the closing door for the opening, thus forming a seal. On at least one inside side wall of the channel of the gripping part (2), one or more gripping elements (14) are integrally mounted. Each such gripping element comprises a thin Web-like support (18) with an enlarged end or foot (16). Each foot presents a relatively large surface area which makes frictional area contact with the mount to hold the gripping part (2) in position. Each foot (16) has foot portions (16B, 16C) lying on opposite sides of a plane through the foot and through the support (18). Any “pull-off force” tending to remove the strip from the flange (22) will tend to cause each foot (16) to pivot in a clockwise direction (as viewed in the Figure) on the support (18). One foot portion (16C) will tend to move away from frictional contact with the flange (22). The other foot portion (16B) will be forced into tighter frictional contact with the flange (22) and will thus provide high resistance to pull-off forces.

### BACKGROUND OF THE INVENTION

The invention relates to a sealing, trimming or finishing strip, comprising a longitudinally extending channel-shaped gripping part for embracingly gripping a mount, at least one inside side wall of the channel supporting a gripping element in the form of a relatively thin web of flexible material extending inwardly of the channel from an integral junction with the side wall and also extending along the length of the strip, the web having a thickness which increases progressively in the direction away from the side wall to form at its distal edge a foot of enlarged cross-section compared with the web.

### DESCRIPTION OF RELATED ART

Such a strip is shown, for example, in DE-A-3 239 752. Here, the foot is offset in relation to the web. Resistance against removal of the gripping part from the mount is primarily produced by a wedging action between the gripping element and the gripping part.

Another such strip is shown in U.S. Pat. No. 4,695,499. In this case, resistance against removal of the gripping part from the mount is produced by wedging of the foot between the mount and a separate stop member extending from the inside side wall of the channel adjacent the web.

### SUMMARY OF THE INVENTION

According to the invention, the sealing, trimming or finishing strip as first set forth above is characterised in that characterised in that the foot has two integral foot portions which define respective distal surface portions integrally forming a distal foot surface, the two foot portions being positioned on opposite sides of a plane which is substantially perpendicular to the foot surface and extends through and parallel to the length of the web, the foot surface being resiliently forced into frictional area contact with the mount when the gripping part embraces the mount with the web extending tranverse to the mount, the web being pivotal at its junction with the side wall of the channel such that any tendency of movement of one of the surface portions away from the mount urges the other surface portion thereof into firmer frictional contact with the mount to resist removal of the gripping part from the mount.

### BRIEF DESCRIPTION OF THE DRAWINGS

Sealing, trimming and finishing strips embodying the invention will now be described, by way of example only, with reference to the accompanying diagrammatic drawings in which:

FIG. 1 is a cross-section through one of the strips, prior to its engagement with the flange around an opening in a vehicle body;

FIG. 2 is a cross-section of the strip shown in FIG. 1 but in engagement with the flange;

FIG. 3 is a cross-section of the strip of FIG. 1 but in an alternative configuration;

FIG. 4 is a cross-section of another one of the strips, prior to its engagement with the flange;

FIG. 5 is a cross-section of the strip shown in FIG. 4 but in engagement with the flange;

FIG. 6 is a cross-section of the strip shown in FIG. 4 but in a different configuration; and

FIGS. 7a to 7j show cross-sections through different forms of gripping element used in the strips embodying the invention.

### DESCRIPTION OF THE PREFERRED EMBODIMENTS

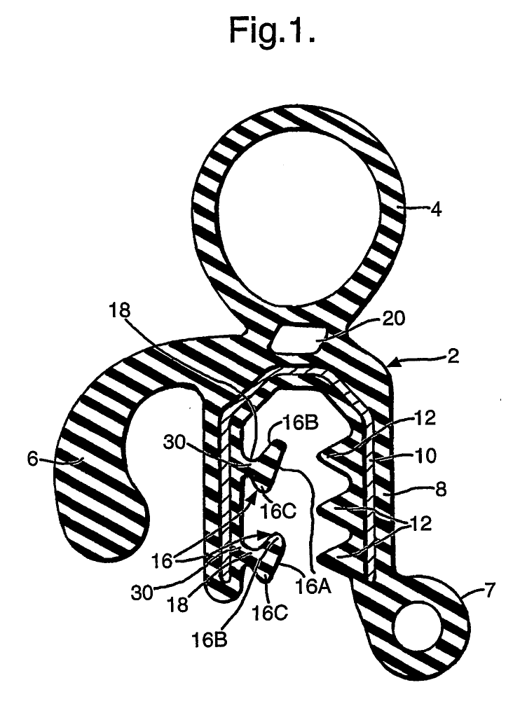

In FIGS. 1 to 3, the strips each include a channel-shaped gripping part 2, a soft hollow sealing part 4, an external lip (termed a “cosmetic lip”) 6 and a soft sealing bead 7. The strip is to be secured on a mount in the form of a flange which forms the frame of an opening in a motor vehicle body, such as a door opening or a luggage compartment opening. In the present case, the strips are suitable for fitting to the flange around a luggage compartment as will be explained in more detail below.

The strips are formed from extruded material 8 such as plastics or rubber material or a thermoplastic elastomer material. Alternatively, they may be produced by a moulding operation. Advantageously, a channel-shaped reinforcing element or carrier 10 is incorporated into the channel of the gripping part 2. The carrier 10 may be made of suitable resilient material such as metal, for example. It may comprise an unapertured channel or a channel formed with slits or slots to increase its flexibility. Instead, it can comprise a series of U-shaped elements placed side by side along the length of the channel and either completely separate from each other or connected together by integral connecting links. Instead, the carrier 10 may be formed from wire, looped to and fro to form the required channel-shape. Other forms of carrier are possible. The purpose of the carrier is to increase the resilience of the gripping part 2, as will be explained.

The carrier 10 may be incorporated into the extruded material during the actual extrusion process, using a cross-head extruder.

The extruded material 8 of the gripping part 2 is integrally formed with gripping elements 12,14. The gripping elements 12 are in this example of the strip formed with a generally triangular cross-section. The gripping elements 14 have enlarged ends or feet 16 which are supported from the adjacent channel wall by thin connecting legs or webs 18.

Although FIG. 1 shows three gripping elements 12 and two gripping elements 14, there may be other numbers of these gripping elements. The gripping elements 12,14 extend longitudinally along the strip with constant cross-section.

The strip may have a hollow longitudinal chamber 20 to provide additional flexibility.

The extrusion process may be arranged so that different parts of the material have different hardness. For example, the material forming the gripping part 2 may be relatively hard, while the sealing part 4 may be softer, such as of cellular form. The cosmetic lip 6 and the bead 7 may be of intermediate hardness. The gripping elements 12 and 14 may be made of softer material.

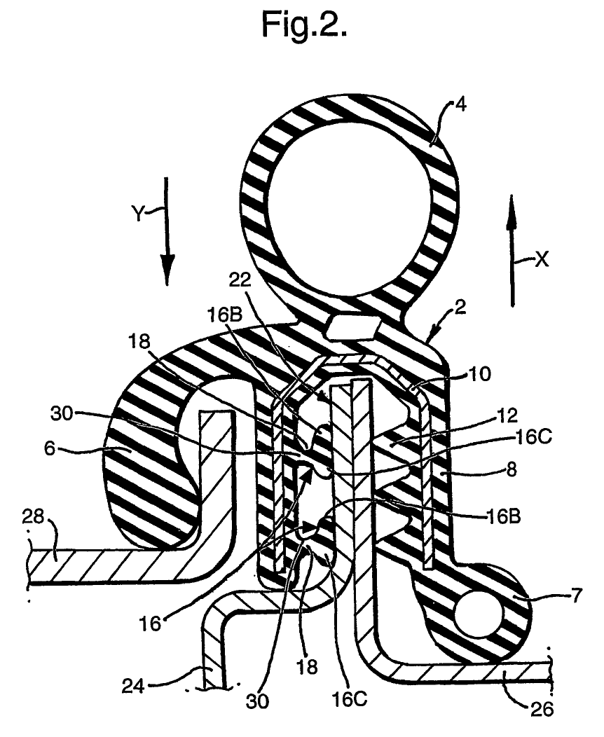

FIG. 2 shows the strip of FIG. 1 placed in position on the mount or flange 22. This flange is formed by the inner and outer body panels 24,26 of the vehicle which meet around an opening in the motor vehicle body. In this case, the flange 22 is the flange running around a luggage compartment opening in a motor vehicle body, and the gripping part 2 thus supports the sealing part 4 so that it projects vertically upwards and becomes partially compressed by the closing lid of the luggage compartment to provide a seal.

The cosmetic lip 6 is used to receive and hide the edge of a trim panel 28 on the inside of the luggage compartment. The sealing bead 7 makes sealing contact with the body panel 26.

In order to provide effective support for the sealing part 4, and to provide and maintain a pleasing appearance, it is very important that the gripping part 2 is held firmly on the flange 22. This function is provided by the gripping elements 12,14, which are pressed resiliently into contact with opposite sides of the flange 22 by the resilient carrier 10. More particularly, and in accordance with a feature of the invention, enhanced gripping strength is achieved by the particular configuration of the gripping elements 14. As shown in the Figures, the enlarged feet 16 provide relatively flat and relatively large contact surfaces 16A; these relatively large areas thus increase the frictional force acting against the flange 22 for holding the gripping part 2 in position. The gripping force is further enhanced by the particular configuration of the gripping elements 14. As shown in FIG. 1, each foot 16 tends to face obliquely towards the mouth of the channel of the gripping part 2 when the strip is not in position on the flange, the web 18 with its foot 16 pivotting on the gripping part 2 at the integral junction 30 between the web 18 and the channel side wall. However, as shown in FIG. 2, the contact between the flat surface 16A of each foot 16 and the adjacent surface of the flange 22 causes the connecting legs 18 to extend substantially perpendicularly to the adjacent inside wall of the gripping part 2. Because each foot 16 has foot portions 16B and 16C respectively on opposite sides of a plane through the connecting foot 16 and substantially perpendicular to the foot surface 16A and to the flange 22, there will be increased resistance to a force tending to pull the strip off the flange 22 (in the direction X): any such force would tend to pivot each foot 16 about the respective pivot point 30 where its web 18 integrally joins the channel side wall, so that the foot portions 16C would bend away from the flange 5. However, such bending movement would press the foot portions 16B more strongly into contact with the flange, thus providing very high resistance to pull-off forces. Each web 18 increases progressively in thickness in the direction from the junction 30 towards the foot 16 giving a generally triangular shape as viewed in cross-section in the Figures, thus tending to fix the pivot point at the junction 30.

Although one of the most significant requirements for the gripping part 2 is to provide a high resistance to pull-off forces, it is also of course required that the strip be relatively easy to mount in position on the flange. In other words, it should preferably have a low push-on force (that is, a force acting in the direction Y). A strip having a configuration shown in FIG. 1 will be relatively difficult to place in position on the flange because the features of the gripping elements 14, which provide high resistance to pull-off forces, will also act to resist push-on forces. Thus, during fitting, the large area surfaces 16A of the gripping elements 16 will make frictional contact with the side of the flange, and the connecting legs 16 will tend to bend into the depth of the channel (that is, in the opposite direction to that shown in FIG. 1), causing the foot portions 16C to be pressed into tight frictional contact with the flange surface.

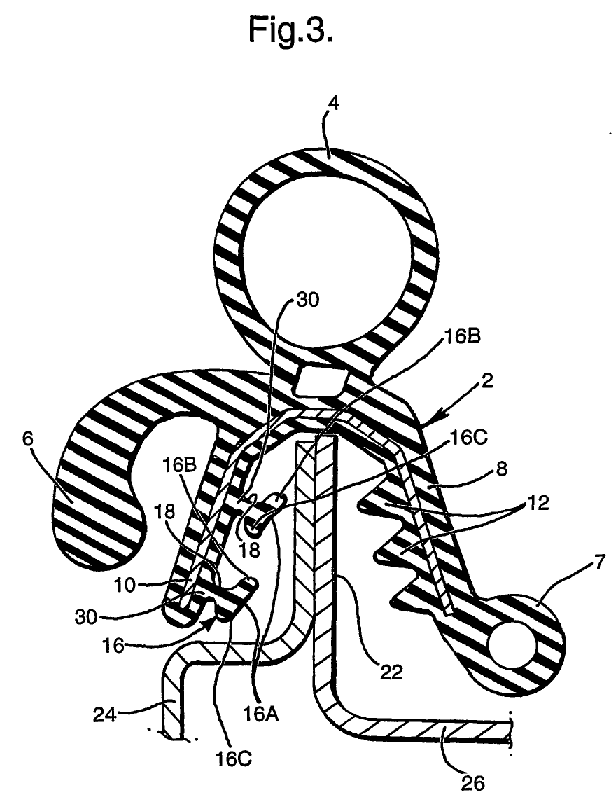

Therefore, it may be preferable to mount the strip on the flange by forming it initially into the configuration shown in FIG. 3 where the channel side walls are splayed slightly outwardly. This enables the gripping part 2 to be placed over the flange 22 without any difficulty. The channel side walls can then be forced into the configuration shown in FIG. 2, such as by using a special tool as described in our U.K. Patent Specifications Nos. 2212844 and 2215762 for example.

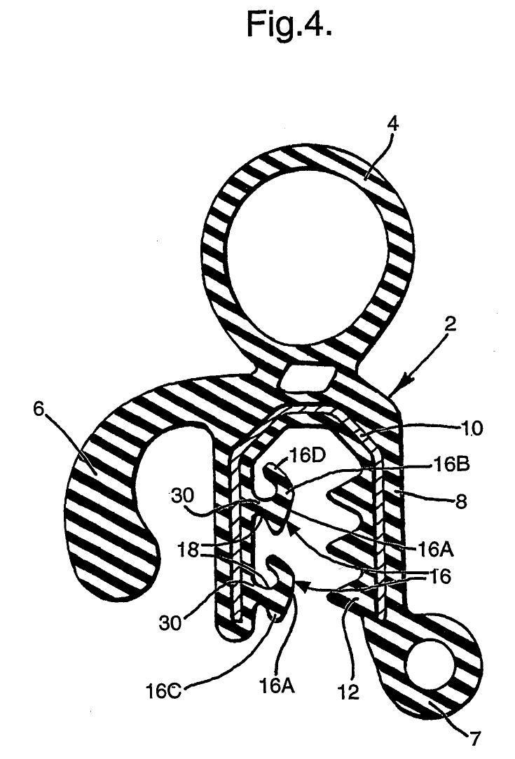

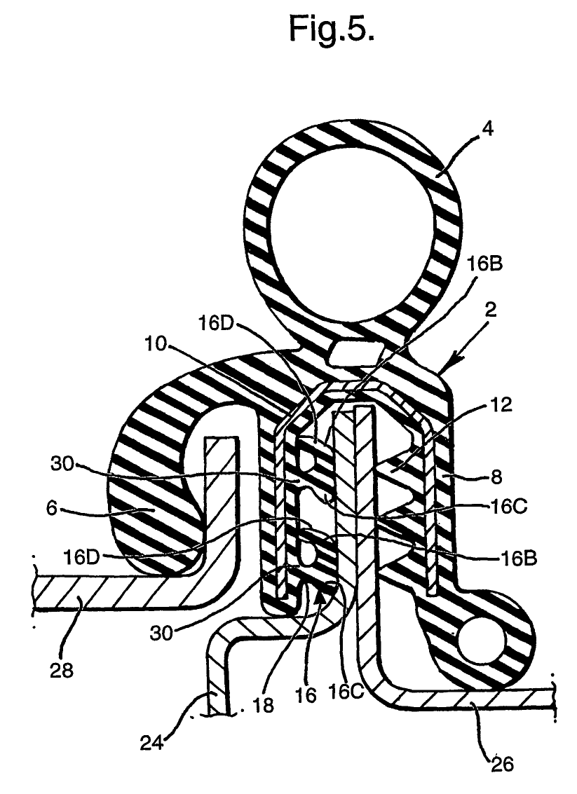

FIG. 4 shows a modified form of the strip which helps to overcome the problem of a high push-on force. As shown in FIG. 4, the gripping elements have feet 16 of modified shape. More specifically, each foot portion 16B has an extension 16D which is curved towards the adjacent inside side wall of the channel of the gripping part 2. When the strip is placed onto the flange 22 and pushed into position in the direction Y (FIG. 2), the feet extensions 16D make contact with the side wall of the channel, as shown in FIG. 5. “Over-tilting” of the feet 16 during the push-on process is now prevented, and this helps to reduce the push-on force. However, the feet extensions 16D do not reduce the high resistance of the strip to pull-off forces.

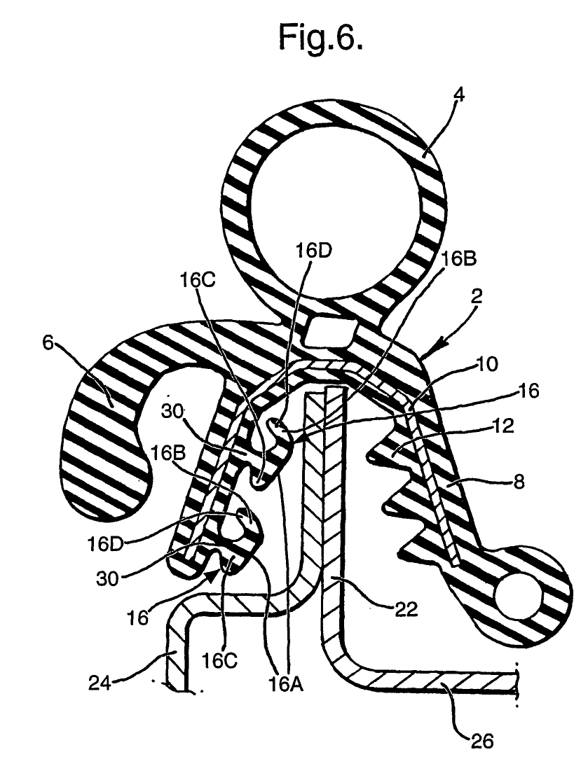

A strip having gripping elements 14 with the configuration shown in FIGS. 4 and 5 can still be fitted, of course, in a configuration in which the side walls of the channel are initially splayed-apart—as shown in FIG. 6, the splayed-apart walls then being forced towards the flange in the manner explained in conjunction with FIG. 3.

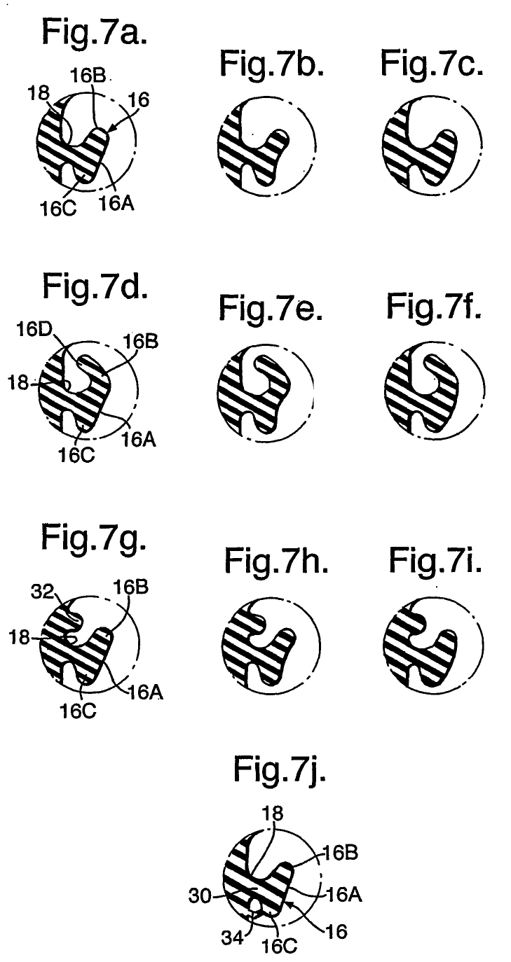

FIGS. 7a to 7j show various modifications to the shape of the feet 14 which are possible.

FIG. 7a shows a foot generally having the same configuration as shown in FIGS. 1 to 3.

FIG. 7b shows a foot having a modified shape to its surface 16C, this surface having a concave shape to enhance the force between the portions 16B and 16C against the flange surface. In FIG. 7c, the foot surface 16C has a convex shape to increase the overall force between the foot and the flange surface.

The feet shown in FIGS. 7d to 7f have the foot extensions 16D discussed above in relation to FIGS. 4 to 6. The shapes of their surfaces 16C respectively correspond to those shown in FIGS. 7a to 7c.

FIGS. 7g to 7i show that the positive effect of the feet extensions 16D (reducing the push-off force) can instead be achieved by providing protrusions 32 on the channel side wall, instead of the feet extensions. During the process of pushing the gripping part 2 onto the flange 22, any tendency of the foot portions 16B to tilt towards the channel side wall (thus undesirably increasing the push-on force) will be resisted by contact between the foot portions 16B and the protrusions 32.

In FIGS. 7g to 7j, the surfaces 16C of the feet respectively have the same shapes as shown in FIGS. 7a to 7c.

FIG. 7j shows a thin flexible integral link 34 connecting the foot portion 16C to the adjacent channel side wall. This link resists any tendency of the foot portions 16B to tilt undesirably towards the channel wall during push-on, in the same way as the extensions 16D or the protrusions 32.

If the strip were to be fitted to a flange around a door opening, instead of around a luggage compartment opening, the sealing part 4 would be mounted on the outside of the side wall 2A of the gripping part 2 instead of on the outside of its base. The sealing part would thus then be mounted in such a position as to be partially compressed by the closing door, therefore providing a sealing function.

However, it will be appreciated that the beneficial effects of the gripping elements 14 can be usefully provided when the strip is merely required to provide a trimming or finishing function—that is, it comprises merely a channel without the sealing part 4 and the cosmetic lip 6.

1. A sealing, trimming or finishing strip, comprising a longitudinally extending channel-shaped gripping part (2) for embracingly gripping a mount (22), at least one inside side wall of the channel supporting a gripping element (14) in the form of a relatively thin web (18) of flexible material extending inwardly of the channel from an integral junction (30) with the side wall and also extending along the length of the strip, the web (18) having a thickness which increases progressively in the direction away from the side wall to form at its distal edge a foot (16) of enlarged cross-section compared with the web (18), characterised in that the foot (16) has two integral foot portions (16B,16C) which define respective distal surface portions integrally forming a generally flat distal foot surface (16A), the two foot portions (16B,16C) being positioned on opposite sides of a plane which is substantially perpendicular to the foot surface (16A) and extends through and parallel to the length of the web (18), the foot surface (16A) being resiliently forced into frictional area contact with the mount (22) when the gripping part (2) embraces the mount (22) with the web (18) extending tranverse to the mount (22), the web (18) being pivotal at its junction (30) with the side wall of the channel such that any tendency of movement of one of the surface portions (16B,16C) away from the mount (22) urges the other surface portion (16B,16C) thereof into firmer frictional contact with the mount (22) to resist removal of the gripping part (2) from the mount (22).

2. A strip according to claim 1, characterised in that there is a second, similar, gripping element (14) mounted on the said inside side wall of the channel.

3. A strip according to claim 1 or 2, characterised in that the or each gripping element (14) extends longitudinally with substantially constant cross-section along the length of the strip.

4. A strip according to any preceding claim, characterised by one or more formations (12) on the opposite inside channel side wall for making frictional contact with a part of the mount (22) opposite to the part thereof contacted by the foot of the or each gripping element (14).

5. A strip according to claim 4, characterised in that the said formation (12) is a said gripping element (14).

6. A strip according to any preceding claim, including blocking means (16D;32;34) for substantially preventing a first one of the two surface portions of the or each gripping element (14) from pivotting into firmer frictional contact with the mount (22) when the gripping part (2) is bodily forced into embracing relationship with the mount (22).

7. A strip according to claim 6, characterised in that the said first surface portion of the or each gripping element (14) is closer to the open mouth of the channel of the gripping part (2) than the other surface portion of that gripping element (14).

8. A strip according to claim 6 or 7, characterised in that the blocking means comprises abutment means (16D,32) for substantially preventing pivotal movement of the other surface portion of the or each gripping element (14) in a direction away from the mount (22) whereby substantially to prevent consequent movement of the first surface portion of the or each gripping element (14) into the firmer frictional contact with the mount (22).

9. A strip according to claim 8, characterised in that the abutment means comprises an extension (16D) on the foot portion (16B) carrying said other surface portion, this extension (16D) being positioned for abutting the adjacent inside side wall of the channel.

10. A strip according to claim 8, characterised in that the abutment means comprises a protrusion (32) outwardly of the inside side wall of the channel adjacent the foot portion (16B) carrying the said other surface portion, this protrusion (32) being positioned for abutting that foot portion (16B).

11. A strip according to claim 8, characterised in that the blocking means comprises a flexible attachment (34) between the foot portion (16C) carrying the first surface portion and the adjacent inside side wall of the channel for preventing the movement of the first surface portion towards the mount (22).

12. A strip according to any preceding claim, characterised in that the said distal foot surface (16A) is at least slightly concave in shape.

13. A strip according to any one of claims 1 to 11, characterised in that the said distal foot surface (16A) is at least slightly convex in shape.

14. A strip according to any preceding claim, characterised in that it is substantially made of elastomeric material.

15. A strip according to any preceding claim, characterised by a channel-shaped carrier or reinforcement (10) made of resilient material and embedded in the channel of the gripping part (2).

16. A strip according to any preceding claim, characterised by a soft sealing part (4) carried by an external surface of the gripping part (2) whereby to be positioned when the gripping part (2) embraces the mount (22) to be at least partially and sealingly compressed by a closure member for an opening which is at least partly framed by the mount (22).
